(19) United States
(12) Patent Application Publication
(10) Pub. No.: US 2026/0367348 A1
(43) Pub. Date: Nov. 19, 2026

(54) ROLLABLE FIBER OPTIC RIBBON

(71) Applicant: CommScope Technologies LLC, Claremont, NC (US)

(72) Inventor: Christopher Paul GEMME, Hickory, NC (US)

(73) Assignee: CommScope Technologies LLC, Claremont, NC (US)

(21) Appl. No.: 19/470,573

(22) PCT Filed: Mar. 14, 2024
(86) PCT No.: PCT/US2024/019910

§ 371 Date: Sep. 29, 2025

Related U.S. Application Data
(60) Provisional application No. 63/456,228, filed on Mar. 31, 2023.

(51) Int. Cl. G02B 6/44

(52) U.S. Cl. CPC G02B 6/4403; G02B 6/4413; G02B 6/448; G02B 6/4482

(57) ABSTRACT

A rollable fiber optic ribbon with fibers arranged in radial or circumferential patterns. The fibers are aligned using a cone-shaped tip on a crosshead die, with adhesive materials non-continuously or periodically applied between the fibers to bond them together on the inside of the bundle. The fibers may have different colors and be positioned in a predetermined order when the ring is flattened. Rifling the fiber stranding can improve non-preferential bending.

### CROSS-REFERENCE TO RELATED APPLICATION

This application is being filed on Mar. 14, 2024, as a PCT International Application and claims the benefit of U.S. Provisional Application No. 63/456,228 filed on Mar. 31, 2023, the disclosure of which is hereby incorporated by reference in its entirety.

### TECHNICAL FIELD

The present disclosure relates to a rollable optical fiber ribbon and a method of producing the same.

### BACKGROUND

A traditional optical fiber ribbon includes a plurality of optical fibers secured together by a relatively rigid matrix material. The matrix material prevents relative movement between the optical fibers of the fiber ribbon and retains the optical fibers in a row. In particular, the matrix material retains the optical fiber in a linear array such that at any given location along the length of the fiber ribbon the optical fibers are retained in a planar arrangement by the matrix materials. The matrix material protects the optical fibers, allows the optical fibers to be handled as a group and maintains the optical fibers in a predetermined sequence. However, the matrix material also provides the fiber ribbon with a preferred bend orientation and the planar configuration has driven cable designs and fiber management systems having fiber densities that are lower than what is sometimes desired in the marketplace. The optical fibers of a traditional fiber ribbon can be separated from each other (e.g., by stripping off the matrix material) to prepare the optical fibers for splicing or termination.

In recent years, so called “rollable” optical fiber ribbon has increased in commercial acceptance and popularity. In a rollable optical fiber ribbon, the optical fibers are interconnected by bonding material such that the optical fibers are maintained in a predetermined sequence and can be handled together as a group. However, in contrast to a traditional optical fiber ribbon, the optical fibers of a rollable fiber ribbon can be moved relative to one another to a rolled, bunched, or other type of non-planar configuration. The mechanical attributes of rollable optical fiber ribbon have opened the possibility for cable configurations and fiber management systems having higher fiber densities than was possible with traditional optical fiber ribbon. Rollable optical fiber ribbons have been developed with different designs. For example, rollable optical fiber ribbon designs can include intermittent connection points between the optical fibers (e.g., staggered or non-staggered connection points), a sheet of flexible matrix material connecting the optical fibers, a continuous layer of slitted matrix material connecting the optical fibers, beads of matrix material connecting the optical fibers, or other ribbon designs. Example documents disclosing example rollable optical fiber ribbons include: U.S. Pat. Nos. 5,682,454; 10,185,105; 9,880,368; 10,488,609; 10,007,078; 9,995,896; 9,086,555; and U.S. Patent Application Publication No. 2020/0271879.

### SUMMARY

One aspect of the present disclosure relates to a rollable fiber optic ribbon comprising multiple fibers (e.g., 12 fibers, etc.) arranged in a radial or circumferential pattern. To achieve the alignment of longitudinal fibers, a cone-shaped tip on a crosshead die is utilized to guide the fibers in a desired pattern. After alignment, adhesive materials are non-continuously or periodically extruded from the cone-shaped tip of the crosshead die, resulting in bonding between fibers on the inside of the fiber bundle. In certain embodiments, the die in the crosshead cones the fiber down to meet the adhesive, which may be a foaming matrix material. Further rifling of the fiber stranding can enhance non-preferential bending.

In one embodiment, the optical fiber arrangement includes a continuous ring shaped ribbon made up of a plurality of optical fibers bonded together. The ribbon length can extend along the central axis of the ring, and adjacent fibers within the ring can be bonded together at discrete locations along the ribbon length. In some embodiments, bonding locations are located on the inside of the ring, with a staggered arrangement along the ribbon length. In some embodiments, the optical fibers may have different colors and can be positioned in a predetermined order when the ring is collapsed into a planar arrangement.

In certain implementations, the optical fiber arrangement includes an optical fiber ribbon including a plurality of optical fibers bonded together to form a continuous ring. In certain implementations, the optical fiber ribbon extends along a ribbon length that extends along a central axis of the ring, and wherein adjacent ones of the optical fibers are bonded together at discrete bonding locations along the ribbon length of the optical fiber ribbon. In certain implementations, the continuous ring includes an inside and an outside, and wherein the discrete bonding locations are located at the inside of the continuous ring. In certain implementations, the discrete bonding locations are staggered along the ribbon length. In certain implementations, the optical fibers have different colors. In certain implementations, the optical fibers are positioned such that when the ring is collapsed to a planar arrangement the optical fibers are arranged in a predetermined order.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a length of an optical fiber arrangement, in accordance with an embodiment of the disclosure.

FIG. 2 is a cross-sectional view of an optical fiber arrangement, in accordance with an embodiment of the disclosure.

FIG. 3 is a cross-sectional view of an optical fiber arrangement, in accordance with an alternative embodiment of the disclosure.

FIG. 4 is a cross-sectional view of an optical fiber arrangement, in accordance with an alternative embodiment of the disclosure.

FIG. 5 is a schematic view of a manufacturing line for an optical fiber arrangement, in accordance with an embodiment of the disclosure.

FIG. 6 is a schematic view of a cone-shaped tip of a bonding material application station within a manufacturing line, in accordance with an embodiment of the disclosure.

FIG. 7 is a cross-sectional view depicting an optical fiber arrangement in an unbiased radial arrangement, in accordance with an embodiment of the disclosure.

FIG. 8 is a cross-sectional view depicting the optical fiber arrangement of FIG. 5 in which an external force is applied, thereby deforming the optical fiber arrangement, in accordance with an embodiment of the disclosure.

FIG. 9 is a cross-sectional view depicting the optical fiber arrangement of FIG. 6, in which the optical fiber arrangement is further deformed into two layers, in accordance with an embodiment of the disclosure.

FIG. 10 is a cross-sectional view depicting the optical fiber arrangement of FIG. 7, in which the two layers begin to merge into a single layer, with optical fibers in the first layer being interspersed between optical fibers and the second layer, in accordance with an embodiment of the disclosure.

FIG. 11 is a cross-sectional view depicting the optical fiber arrangement of FIG. 9, in which the optical fibers are aligned in a single layer, in accordance with an embodiment of the disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

The present disclosure is directed to a rolled optical fiber ribbon and methods of manufacturing the same. One aspect of this invention is the rollable fiber optic ribbon, which comprises multiple fibers arranged radially or circumferentially. To align the longitudinal fibers, a cone-shaped tip on a crosshead die guides the fibers in the desired pattern. Adhesive materials are non-continuously or periodically extruded or otherwise ejected (sprayed, etc.) from the cone-shaped tip, bonding the fibers on the inside of the fiber bundle. By rolling the optical fiber ribbon during manufacturing, the rolled configuration becomes its natural state, allowing it to be stored coiled on a reel. This makes it easy to pay out from storage reels and facilitates subsequent cable manufacturing since the optical fiber ribbons can be fed directly from storage reels into the cable jacket or core stranding fixture. When splicing (e.g., mass-fusion splicing) or connectorization (i.e., terminating the optical fibers at one or more optical connectors) is needed, the optical fiber ribbon can be transitioned to a planar configuration or the fibers can be separated into a planar configuration.

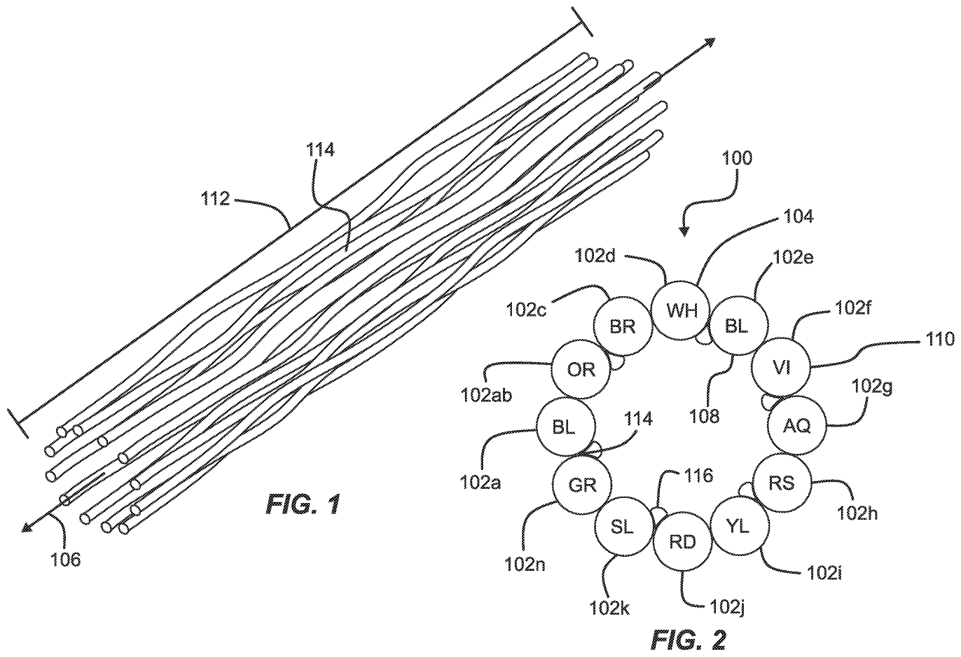

Referring to FIG. 1, a perspective view of a partially expanded optical fiber arrangement 100 is depicted in accordance with an embodiment of the disclosure. FIG. 2 depicts a cross-sectional view of an optical fiber arrangement 100. Two or more optical fibers 102 can be bonded (e.g., adhesively bonded) together in a consecutive sequence from a first fiber 102a to a last fiber 102n to form the optical fiber arrangement 100. Collectively, the optical fibers 102 can be adhesively bonded together at discrete bonding locations 114 to form a continuous ring 104, arranged radially or circumferentially around an axis 106, so as to define an inside 108 and an outside 110 of the continuous ring 104. A ribbon length 112 can be defined as extending between the end faces of the optical fibers 102, generally perpendicular to the continuous ring 104.

In the example shown, twelve optical fibers 102a-n are bonded together to form the optical fiber arrangement 100. In other implementations, the optical fiber arrangement may include a greater or lesser number (e.g., four, six, eight, ten, sixteen, twenty-four, thirty-six, etc.) of optical fibers 102. In certain examples, the optical fibers 102 each include a core, a cladding layer surrounding the core, and a coating layer surrounding the cladding layer. In one example, the coating layers each have an outer diameter in the range of 240-260 microns and the optical fibers of the ribbon have a center-to-center spacing in the range of 240-260 microns. In other examples, the coating layers each have an outer diameter in the range of 190-210 microns and the optical fibers of the ribbon have a center-to-center spacing in the range of 190-210 microns.

In some implementations, each fiber 102 is color-coded to differentiate it from the other fibers. The fibers 102 are typically color-coded using a specific set of colors, which is standardized in the industry, for example, including blue, orange, green, brown, slate (or gray), white, red, black, yellow, violet, rose, and aqua. Each fiber 102 in the optical fiber arrangement 100 can be identified by a specific color that is applied to the coating of the fiber 102, which enables technicians to easily identify and differentiate between the fibers 102 and to allow tracing of individual fibers 102 within the optical fiber arrangement 100.

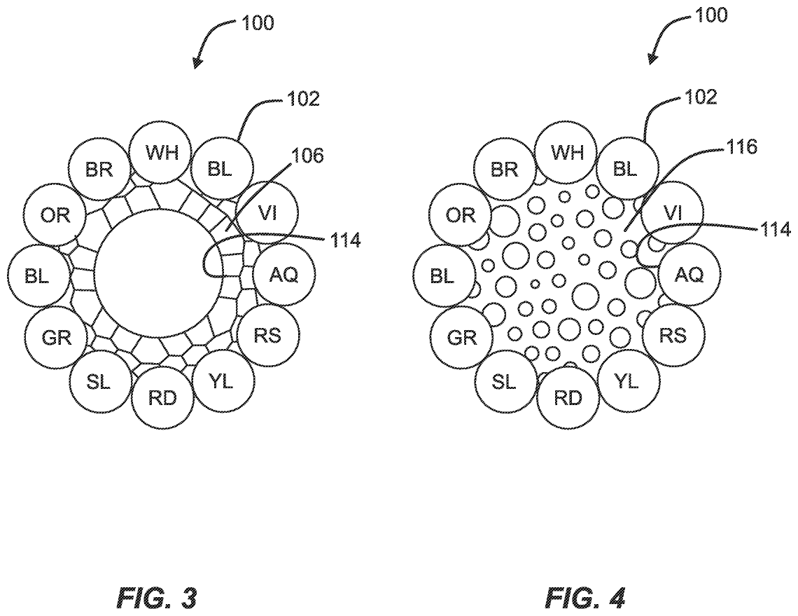

The optical fibers 102 can be bonded together using bonding material 116 which may include a curable material having adhesive characteristics such as a curable adhesive. In certain examples, the bonding material 116 includes a curable material that is cured via time or the application of energy (e.g., radiant energy such as heat or light (e.g., ultraviolet radiation). In certain examples, the bonding material 116 is an adhesive such as an epoxy. In some implementations, the bonding material 116 may comprise a thermoplastic foam material or a foaming thermoset material, which can be applied using a spray technique. In some implementations, the bonding material 116 is applied to the optical fibers 102 on the inside 108 of the continuous ring 104 (as depicted in FIG. 3). In one embodiment, the optical fibers 102 can be held in position relative to one another by a solid foam core (as depicted in FIG. 4).

In some implementations, the bonding material 116 is applied to the optical fibers 102 in discrete or intermittent volumes (e.g., beads, dots, etc.) at intermittent discrete bonding locations 114 along the optical fibers 102. In other implementations, the bonding material 116 is applied continuously along the optical fibers 102. The optical fiber arrangement 100 maintains the optical fibers 102 in a consecutive sequence so that specific ones of the optical fibers 102 can be identified at both axial ends of the optical fiber arrangement 100.

In certain implementations, the discrete volumes of bonding material 116 are disposed in geometric patterns along the length of the optical fiber arrangement 100. In some implementations, the bonding material 116 is applied in a common, repeated pattern (i.e., the patterns are mirrored). As depicted in FIG. 1, not all optical fibers 102 are bonded together along the same transverse cross-sectional plane. For example, the bonding material 116 may be distributed so that only one pair of optical fibers 102 is bonded together per transverse cross-sectional plane.

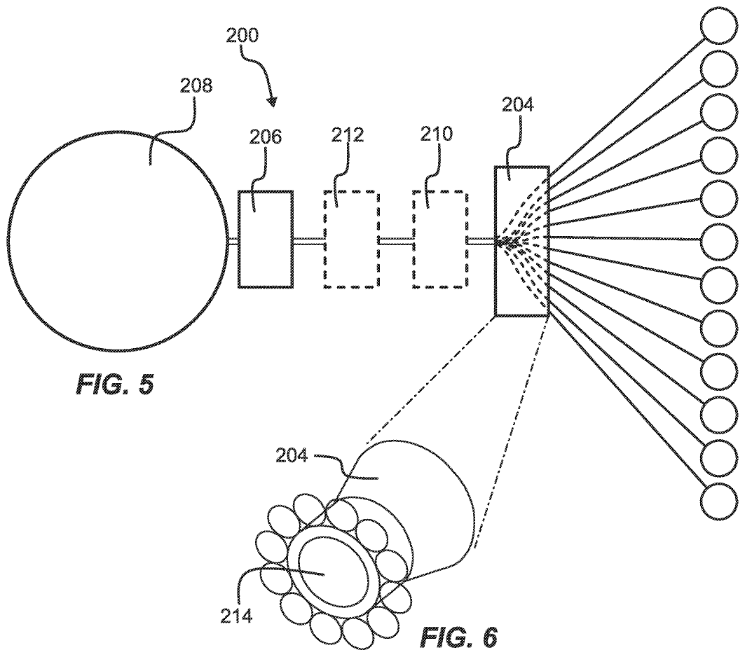

Referring to FIG. 5, a manufacturing line 200 for forming a fiber optical arrangement 100 is depicted in accordance with an embodiment of the disclosure. The manufacturing line 200 includes a plurality of payoff reels 202a-n, at least one bonding material application station 204 (e.g., a coating head, an extrusion die, etc.), a stranding arrangement 206, and a take-up reel 208. In some implementations, the manufacturing line 200 may include a curing station 210. In other implementations, the application station 204 also cures the bonding material 116. In certain implementations, the manufacturing line 200 may include an accumulator or other tensioning station 212 (e.g., a nip defined between driven rollers, a capstan, an accumulator, etc.) before the take-up reel 208. In certain examples, tension on the fibers 102 can be relieved or reduced at or after the tensioning structure 212 before the optical fiber arrangement 100 is reeled on the take-up reel 208. In such cases, the optical fiber arrangement 100 can be arranged in a rolled configuration at the time the optical fiber arrangement 100 is reeled onto the take-up reel 208.

Each optical fiber 102 is paid out from a respective one of the payoff reels 202 (e.g. by the tensioning station 212). The fibers 102 are routed from the reels 202 towards the application station 204. At the application station 204, the fibers 102 are arranged radially or circumferentially and the bonding material 116 is applied. For example, as further depicted in FIG. 6, in some embodiments, the application station 204 can include a cone-shaped tip 214 configured to guide the fibers 102 into the radial arrangement. After alignment, bonding material 116 is extruded from the cone-shaped tip 214, resulting in bonding between fibers 102 on the inside of a formed fiber bundle. In some embodiments, the cone-shaped tip 214 forces the individual fibers 202 into the extruded bonding material, which can be a foaming matrix material. In some embodiments, the cone-shaped tip can be configured to add a rifling twist to the individual fibers 202 to enhance non-preferential bending.

In some implementations, the optical fibers 102 are then routed to an oven, a source of radiant energy such as a UV light emitter, or other curing station 210 to cure the dispensed bonding material 116. In other implementations, the application station 204 also is configured to cure the dispensed bonding material 116, such that the bonding material 116 may be applied and cured at the same application station 204. In some implementations, curing is sufficient to hold the fibers 102 in position, but enables some stretching or deformation of the bonding material 116 to accommodate further movement of the fibers 102 in the optical fiber arrangement 100. In such implementations, the final cure can be applied to the bonding material 116 at the curing station 210 that also compresses or otherwise shapes the optical fiber arrangement 100 into a final configuration.

In certain implementations, the optical fiber arrangement 100 is helically twisted by the manufacturing line 200. For example, the fiber optical arrangement 100 may be twisted along a lay length over an axial length of the optical fiber arrangement 100 in addition to being curled into a radial or circumferential configuration. In other examples, the fiber optical arrangement 100 is Z-stranded. In certain implementations, the fiber optical arrangement 100 can be twisted in a first direction (e.g., clockwise, counter-clockwise, etc.) and can be stranded with another optical fiber arrangement 100 or other component in an opposite second direction. Stranding the fiber optical arrangement 100 in the opposite direction as the twist may relieve tension on the optical fibers 102 of the optical fiber arrangement 100. For example, a lay length of the stranding can be selected to remove the twist from the fiber 100.

In certain examples, the optical fiber arrangement 100 can be stranded with one or more additional fiber ribbons. In certain examples, the optical fiber arrangement 100 can be stranded with one or more electrical conductors to form a hybrid cable. In certain examples, the fiber optical arrangement 100 can be stranded with one or more strength members (e.g., a glass reinforced polymer (GRP) rod), a colored thread, or other such component. In another example, the cable component may be twisted around the fibers 102. For example, a water blocking tape, a colored thread, strength members (e.g., aramid yarn) may be wrapped around the fibers 102.

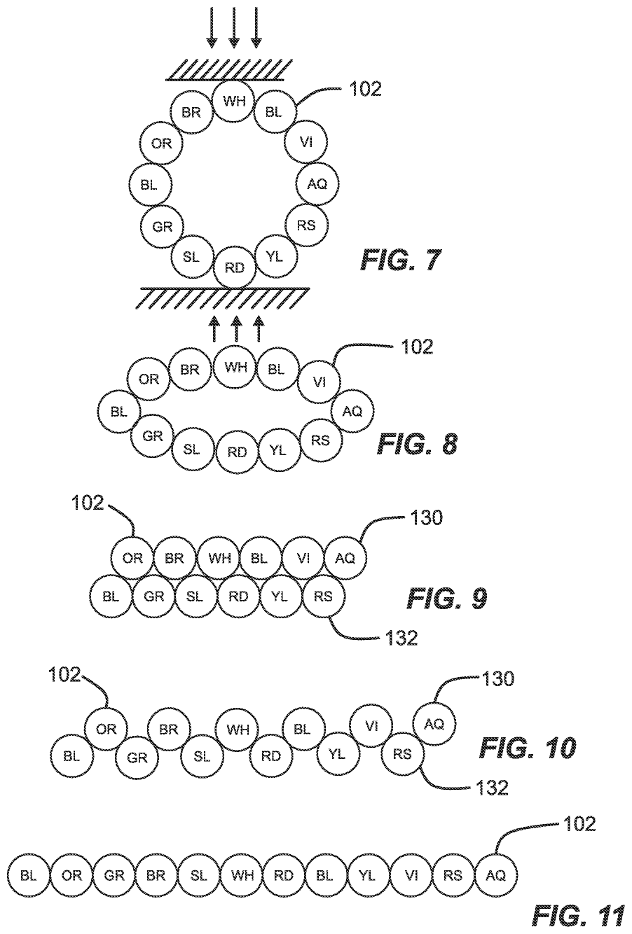

With additional reference to FIGS. 7-11, when splicing (e.g., mass-fusion splicing) or connectorization (i.e., terminating the optical fibers at one or more optical connectors) is needed, the optical fiber ribbon can be transitioned to a planar configuration or the fibers can be separated into a planar configuration. In particular, application of an external force on the outside 110 of the continuous ring 104 can cause the continuous ring 104 to deform, first into a general oval shape (as depicted in FIG. 8), which eventually collapses into two essentially planar layers of optical fibers 102 (as depicted in FIG. 9), including a top layer 130 and a bottom layer 132. Further application of external force causes the optical fibers 102 to merge into a single layer of optical fibers 102, in which the in which the optical fibers 102 of the top layer 130 are interspersed between the optical fibers 102 of the bottom layer (as depicted in FIGS. 10 & 11).

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. An optical fiber arrangement comprising:
an optical fiber ribbon including a plurality of optical fibers bonded together to form a continuous ring.

2. The optical fiber arrangement of claim 1, wherein the optical fiber ribbon extends along a ribbon length that extends along a central axis of the ring, and wherein adjacent ones of the optical fibers are bonded together at discrete bonding locations along the ribbon length of the optical fiber ribbon.

3. The optical fiber arrangement of claim 1, wherein the continuous ring includes an inside and an outside, and wherein the discrete bonding locations are located at the inside of the continuous ring.

4. The optical fiber arrangement of claim 2, wherein the discrete bonding locations are staggered along the ribbon length.

5. The optical fiber arrangement of claim 1, wherein the optical fibers have different colors.

6. The optical fiber arrangement of claim 5, wherein the optical fibers are positioned such that when the ring is collapsed to a planar arrangement the optical fibers are arranged in a predetermined order.

7. An optical fiber ribbon assembly for cable manufacturing, comprising:
a plurality of elongated optical fibers arranged in a helical configuration to form a flexible ribbon capable of being coiled for storage, wherein each of the plurality of elongated optical fibers is encased within a protective coating, and wherein the plurality of elongated optical fibers are adhesively bonded at intermittent locations along a length of the plurality of elongated optical fibers by a bonding material configured to maintain an assembly of the plurality of elongated optical fibers in a helical configuration, the assembly of the plurality of elongated optical fibers further characterized by the ability to transition from the helical configuration to a planar configuration for connectorization or splicing operations.

8. The optical fiber ribbon assembly of claim 7, wherein the bonding material comprises a curable adhesive that is activated by an external stimulus, including at least one of heat, light, or ultraviolet radiation.

9. The optical fiber ribbon assembly of claim 7, further characterized by the inclusion of a memory material within the bonding material, enabling the assembly of the plurality of elongated optical fibers to retain the helical configuration until a predetermined external force is applied to transition to the assembly of the plurality of elongated optical fibers to the planar configuration.

10. The optical fiber ribbon assembly of claim 7, wherein the intermittent locations of adhesive bonding are staggered along the ribbon length.

11. The optical fiber ribbon assembly of claim 7, wherein the intermittent locations of adhesive bonding form a pattern comprising at least one of dots, beads, or stripes along the length of the optical fibers.

12. The optical fiber arrangement of claim 7, wherein the assembly of the plurality of elongated optical fibers includes an inside and an outside, and wherein the intermittent locations of adhesive bonding are located at the inside of the assembly of the plurality of elongated optical fibers.

13. The optical fiber ribbon assembly of claim 7, further comprising a color-coding scheme for each of the plurality of elongated optical fibers, facilitating identification and differentiation of individual fibers within the assembly of the plurality of elongated optical fibers.

14. The optical fiber ribbon assembly of claim 7, wherein the plurality of elongated optical fibers are positioned such that when the assembly of the plurality of elongated optical fibers is collapsed to the planar configuration, the plurality of elongated optical fibers are arranged in a predetermined order.

15. The optical fiber ribbon assembly of claim 7, wherein the assembly of the plurality of elongated optical fibers is configured to be integrated within a cable structure that includes additional elements, including at least one of a strength member, an electrical conductor, or a water-blocking element.

16. A method for manufacturing an optical fiber ribbon assembly, comprising:
arranging a plurality of elongated optical fibers in a helical configuration to form a flexible ribbon, wherein each of the plurality of elongated optical fibers is encased within a protective coating;
adhesively bonding the plurality of elongated optical fibers at intermittent locations along their length with a bonding material, wherein the bonding material is configured to maintain the assembly of the plurality of elongated optical fibers in a helical configuration; and
configuring the assembly to transition from the helical configuration to a planar configuration for connectorization or splicing operations.

17. The method of claim 16, wherein the bonding material comprises a curable adhesive that is activated by applying an external stimulus, including at least one of heat, light, or ultraviolet radiation.

18. The method of claim 16, wherein the intermittent locations of adhesive bonding are staggered along the length of the ribbon.

19. The method of claim 16, wherein the intermittent locations of adhesive bonding form a pattern comprising at least one of dots, beads, or stripes along the length of the optical fibers.

20. The method of claim 16, further comprising arranging the plurality of elongated optical fibers such that an inside and an outside are defined, and applying the bonding material at the inside of the assembly.
